(19) United States
(12) Patent Application Publication
(10) Pub. No.: US 2026/0127435 A1
(43) Pub. Date: May 7, 2026

(54) COMPRESSING MACHINE-LEARNING MODELS

(71) Applicant: QUALCOMM Incorporated, San Diego, CA (US)

(72) Inventors: Haitam BEN YAHIA, Diemen (NL); Denis KORZHENKOV, Amsterdam (NL); Amir GHODRATI, Amsterdam (NL); Amirhossein HABIBIAN, Amsterdam (NL)

(21) Appl. No.: 19/000,376

(22) Filed: Dec. 23, 2024

Related U.S. Application Data
(60) Provisional application No. 63/717,685, filed on Nov. 7, 2024.

(51) Int. Cl. G06N 3/082; G06N 3/0495

(52) U.S. Cl. CPC G06N 3/082; G06N 3/0495

(57) ABSTRACT

Systems and techniques are described herein for processing data. For instance, a method for processing data is provided. The method may include processing input data using a first merged layer of a machine-learning model to generate first features, wherein the first merged layer is based on a funnel layer and a first linear layer, and wherein the funnel layer is smaller in at least one dimension than the first linear layer; processing the processed input data using a non-linear layer of the machine-learning model to generate second features; and processing the second features using a second merged layer of the machine-learning model to generate an output, wherein the second merged layer is based on a reverse funnel layer and a second linear layer, and wherein the reverse funnel layer is smaller in at least one dimension than the second linear layer.

### CROSS-REFERENCE TO RELATED APPLICATIONS

This application claims the benefit of U.S. Provisional Application No. 63/717,685, filed Nov. 7, 2024, which is incorporated herein by reference in its entirety.

### TECHNICAL FIELD

The present disclosure generally relates to machine-learning models. For example, aspects of the present disclosure include systems and techniques for compressing machine-learning models.

### BACKGROUND

Image and video generative models may generally adhere to scaling laws, where performance enhances with increased model size and computational resources. Current generative models are constrained based on such models being 1) computationally expensive, requiring billions of floating-point operations per second (TFLOPS) of processing power and 2) memory demanding with parameter counts in the order of billions. Such constraints make it difficult to deployment of such models for on-device use cases.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing data. According to at least one example, a method is provided for processing data. The method includes: processing input data using a first merged layer of a machine-learning model to generate first features, wherein the first merged layer is based on a funnel layer and a first linear layer, and wherein the funnel layer is smaller in at least one dimension than the first linear layer; processing the processed input data using a non-linear layer of the machine-learning model to generate second features; and processing the second features using a second merged layer of the machine-learning model to generate an output, wherein the second merged layer is based on a reverse funnel layer and a second linear layer, and wherein the reverse funnel layer is smaller in at least one dimension than the second linear layer.

In another example, an apparatus for processing data is provided that includes at least one memory and at least one processor (e.g., configured in circuitry) coupled to the at least one memory. The at least one processor configured to: process input data using a first merged layer of a machine-learning model to generate first features, wherein the first merged layer is based on a funnel layer and a first linear layer, and wherein the funnel layer is smaller in at least one dimension than the first linear layer; process the processed input data using a non-linear layer of the machine-learning model to generate second features; and process the second features using a second merged layer of the machine-learning model to generate an output, wherein the second merged layer is based on a reverse funnel layer and a second linear layer, and wherein the reverse funnel layer is smaller in at least one dimension than the second linear layer.

In another example, a non-transitory computer-readable medium is provided that has stored thereon instructions that, when executed by one or more processors, cause the one or more processors to: process input data using a first merged layer of a machine-learning model to generate first features, wherein the first merged layer is based on a funnel layer and a first linear layer, and wherein the funnel layer is smaller in at least one dimension than the first linear layer; process the processed input data using a non-linear layer of the machine-learning model to generate second features; and process the second features using a second merged layer of the machine-learning model to generate an output, wherein the second merged layer is based on a reverse funnel layer and a second linear layer, and wherein the reverse funnel layer is smaller in at least one dimension than the second linear layer.

In another example, an apparatus for processing data is provided. The apparatus includes: means for processing input data using a first merged layer of a machine-learning model to generate first features, wherein the first merged layer is based on a funnel layer and a first linear layer, and wherein the funnel layer is smaller in at least one dimension than the first linear layer; means for processing the processed input data using a non-linear layer of the machine-learning model to generate second features; and means for processing the second features using a second merged layer of the machine-learning model to generate an output, wherein the second merged layer is based on a reverse funnel layer and a second linear layer, and wherein the reverse funnel layer is smaller in at least one dimension than the second linear layer.

Systems and techniques are described for compressing machine-learning models. According to at least one example, a method is provided for compressing machine-learning models. The method includes: adding a funnel layer to a network of layers at an output or an input of a first linear layer of the network of layers; adding a reverse-funnel layer to the network of layers at an input or an output of a second linear layer of the network of layers; training the network of layers to perform an operation; merging the funnel layer with the first linear layer; and merging the reverse-funnel layer with the second linear layer.

In another example, an apparatus for compressing machine-learning models is provided that includes at least one memory and at least one processor (e.g., configured in circuitry) coupled to the at least one memory. The at least one processor configured to: add a funnel layer to a network of layers at an output or an input of a first linear layer of the network of layers; add a reverse-funnel layer to the network of layers at an input or an output of a second linear layer of the network of layers; train the network of layers to perform an operation; merge the funnel layer with the first linear layer; and merge the reverse-funnel layer with the second linear layer.

In another example, a non-transitory computer-readable medium is provided that has stored thereon instructions that, when executed by one or more processors, cause the one or more processors to: add a funnel layer to a network of layers at an output or an input of a first linear layer of the network of layers; add a reverse-funnel layer to the network of layers at an input or an output of a second linear layer of the network of layers; train the network of layers to perform an operation; merge the funnel layer with the first linear layer; and merge the reverse-funnel layer with the second linear layer.

In another example, an apparatus for compressing machine-learning models is provided. The apparatus includes: means for adding a funnel layer to a network of layers at an output or an input of a first linear layer of the network of layers; means for adding a reverse-funnel layer to the network of layers at an input or an output of a second linear layer of the network of layers; means for training the network of layers to perform an operation; means for merging the funnel layer with the first linear layer; and means for merging the reverse-funnel layer with the second linear layer.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram symbolically illustrating the three phases of model compression, according to various aspects of the present disclosure and a system for compressing a model, according to various aspects of the present disclosure;

FIG. 2 is a block diagram illustrating an example model (e.g., a machine-learning model);

FIG. 3 is a block diagram illustrating an example model 300 (e.g., a machine-learning model) including funnels, according to various aspects of the present disclosure;

FIG. 4 is a diagram of an example model 400 generated according to various aspects of the present disclosure;

FIG. 5 is a diagram including an illustration of two instances of a model, one including frozen weights and the other including all non-frozen weights;

FIG. 6 is a diagram illustrating a system in which a student model may be trained based on a teacher model, according to various aspects of the present disclosure;

FIG. 7A is a flow diagram illustrating an example process for compressing a machine-learning model, in accordance with aspects of the present disclosure;

FIG. 7B is a flow diagram illustrating an example process for processing data, in accordance with aspects of the present disclosure;

FIG. 8 is a block diagram illustrating an example of a deep learning neural network that can be used to perform various tasks, according to some aspects of the disclosed technology;

FIG. 9 is a block diagram illustrating an example of a convolutional neural network (CNN), according to various aspects of the present disclosure; and

FIG. 10 includes two sets of images that show the forward diffusion process (which is fixed) and the reverse diffusion process (which is learned) of a diffusion model, according to various aspects of the present disclosure;

FIG. 11 includes a diagram illustrating how diffusion data is distributed from initial data to noise using a diffusion model in the forward diffusion direction, according to various aspects of the present disclosure;

FIG. 12 is a diagram illustrating a U-Net architecture for a diffusion model, according to various aspects of the present disclosure;

FIG. 13 is a block diagram of an example transformer in accordance with some aspects of the disclosure;

FIG. 14 is a block diagram illustrating an example process of singular value decomposition that may be used, according to various aspects of the present disclosure to initialize funnels;

FIG. 15 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Generative neural network models (e.g., image and video generative models or other types of generative models) may generally adhere to scaling laws, where performance enhances with increased model size and computational resources. Current generative models have various constraints. For example, generative neural network models (referred to herein as generative models) are computationally expensive, requiring billions of floating-point operations per second (TFLOPS) of processing power. Current generative models are also memory demanding with parameter counts in the order of billions. Such constraints make it difficult to deploy generative models, such as for on-device use cases.

Channel size may be a factor in modern machine-learning-model architectures, such as: transformer blocks, residual blocks, and feedforward blocks. In the present disclosure, the term “channel size” may refer to a dimension (e.g., a width) of neural network layers. Channel size plays an important role in the size of a model. For example, a first model with a first number of channels in each layer may be larger than a second model with fewer numbers of channels in each layer. Increasing the channel size (e.g., by increasing the number of channels in layers of a model) results in a higher number of parameters for the model as well as greater computational cost, and consequently, increased energy consumption. Additionally, increasing the number of channels in layers of a model (e.g., increasing the “channel size”) generally enhances the model's capacity. For example, the first model with the first number of channels may be more capable than the second model with the fewer number of channels.

Systems, apparatuses, methods (also referred to as processes), and computer-readable media (collectively referred to herein as “systems and techniques”) are described herein for compressing machine-learning models, such as large neural network models (e.g., generative models). For example, the systems and techniques described herein may reduce the channel dimension of existing machine-learning models (e.g., neural network models) without significant impact to quality of outputs of the models. The reduction to the channel dimension can lead to a decrease in compute latency as well as a decrease in memory and/or energy consumption.

The systems and techniques may provide benefits, including a reduction in the number of parameters of a machine-learning model (e.g., a reduction to model size), a reduction in computational cost (e.g., computational time and/or power consumption) of running a model, a reduction in energy consumption as a model's size may directly affect operations on the hardware designed to process vectors (HVX) and hardware designed to process matrices (HMX), among others. Additionally, despite providing such benefits, the systems and techniques may cause only a negligible drop in the quality of the output of the models and no changes to the computational-graph layout (which may result in relatively minor additional deployment cost). The systems and techniques may be applicable to any linear layer, including, as examples, attention blocks, feed forward (e.g., FeedForward) blocks, convolution blocks, any combination thereof, and/or other blocks or layers.

The systems and techniques may be implemented to reduce the number of channels within a layer of any neural network. The systems and techniques may enable large machine-learning models (e.g., generative models) to be deployed on relatively constrained devices (e.g., devices with limited processing capacity and/or power limitations). For example, the systems and techniques may enable a large video-generation model (e.g., a text-to-video generation model or an image-to-video generation model) to be deployed (e.g., installed to run) on a personal device (e.g., a smartphone). As another example, the systems and techniques may enable a large video editing model (e.g., a text-based video editing model that may edit video data based on shapes, attributes and/or styles) and/or a large video-enhancement model (e.g., a diffusion-based super-resolution model or a video inpainting model) to be deployed on a personal device.

The systems and techniques introduce linear layers which reduce the number of channels at inference time, the linear layers may be referred to herein as channel funnels. Channel funnels may reduce the number of innermost channels of certain blocks of a machine-learning model.

For example, consider a pretrained neural network with two linear layers, y=W₂h(W₁x), where x∈ [symbol] ^{cin}, W₁∈R^{cimer×cin}, W₂∈ [symbol] ^{cout×cinner}, and h(⋅) is an element-wise non-linear operation. The systems and techniques introduce two additional matrices, F₁∈ [symbol] ^{c′×cinner} and F₂∈ [symbol] ^{cinner×c′}, where c′<cᵢₙₙₑᵣ, and rewrite the network as y′=W₂F₂h(F₁W₁x).

During the funnel finetuning, matrices W₁ and W₂ are frozen and only funnel matrices F₁ and F₂ are trained. After finetuning is finished, the two consecutive linear layers are merged into a single weight matrix, and the resulting innermost dimension cᵢₙₙₑᵣ is replaced with the smaller c′.

As an example, consider a query and key projection matrices in a self-attention similarity map computation, XW_{q}(XWₖ)^{T} with X having a shape of L×cᵢₙ, and W_{q} and Wₖ Of cᵢₙ×cᵢₙₙₑᵣ. With funnel matrices F_{q} and Fₖ of size cᵢₙₙₑᵣ×c′, the systems and techniques modify the aforementioned; bilinear map as

$${XW}_{q} {{F}_{q} ( {XW}_{k} {F}_{k} )}^{T} = {XW}_{q} {F}_{q} {F}_{k}^{T} {W}_{k}^{T} {X}^{T} .$$

The systems and techniques may initialize the funnel matrices in such a way that the resulting effective bilinear form

$${W}_{q} {F}_{q} {F}_{k}^{T} {W}_{k}^{T}$$

mimics the best possible low-rank approximation of the original effective matrix

$${W}_{q} {W}_{k}^{T} .$$

This can be achieved by means of truncated singular decomposition. Namely, let

$${W}_{q} {W}_{k}^{T} = U \sum {V}^{T}$$

be the singular vector decomposition, and

$${U}_{c} {\sum }_{c} {V}_{c}^{T}$$

to be its truncated c-rank version. Then it suffices to set

$${F}_{q} = {W}_{q}^{†} {U}_{{c}^{′}} {\sum }_{{c}^{′}}^{1 / 2}$$

$$and$$

$${F}_{k} = {W}_{k}^{†} {U}_{{c}^{′}} {\sum }_{{c}^{′}}^{1 / 2}$$

to obtain

$${W}_{q} {F}_{q} {F}_{k}^{T} {W}_{k}^{T} \approx {U}_{{c}^{′}} {\sum }_{{c}^{′}} {V}_{{c}^{′}}^{T} ,$$

where † means the Moore-Penrose pseudoinverse.

In the same way, funnel initialization can be applied to value and output projection matrices of the self-attention block. The systems and techniques may, for example, modify all the self-attention blocks by reducing the inner rank of each attention head by a factor of 50%, henceforth referred to as the funnel factor.

Various aspects of the application will be described with respect to the figures below. Illustrative and non-limiting aspects and examples related to the present disclosure are included in Appendix A attached hereto, which is incorporated herein by reference in its entirety for all purposes.

Conventional model compression pipelines generally include three phases: 1) a training phase, where a large model is trained from scratch on a huge datasets, 2) a compression phase, where the trained large model is compressed into a small model, then the small model is finetuned to recover the performance drop, and 3) a deployment phase, where the small model is deployed for fast inference.

The systems and techniques also include a training phase, a compression phase, and an inference phase. However, during the compression phase, the systems and techniques add additional parameters to the model. Adding the additional parameters may avoid the large performance drops from removing model parameters during the compression phase. The additional parameters facilitate the compression phase as the systems and techniques preserves the original model weights, and even increase the overall number of parameters. At deployment, the additional parameters may be merged into the original weights leading to a small model for fast inference.

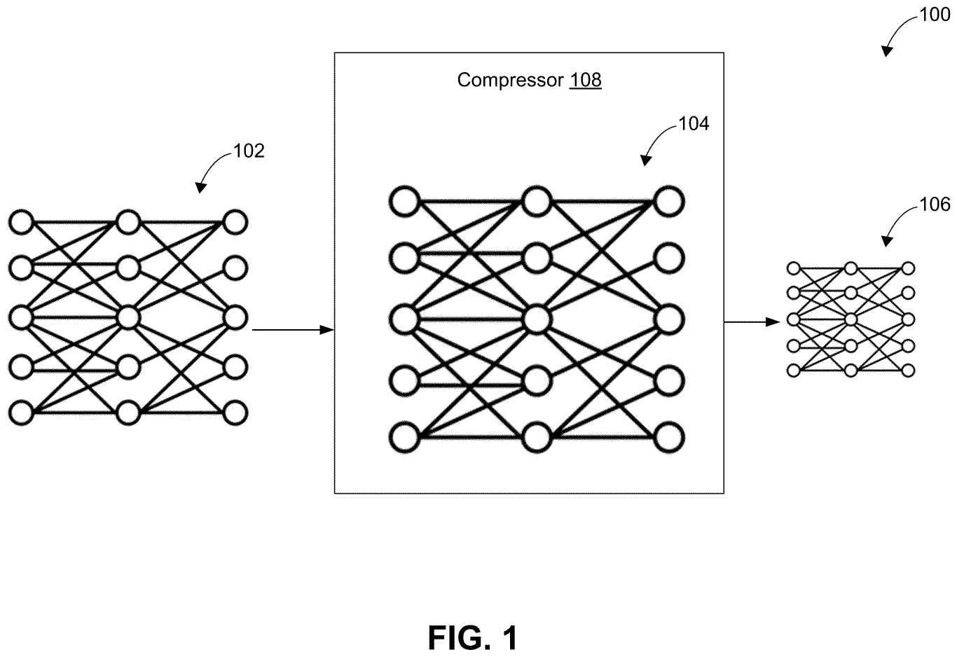

FIG. 1 is a diagram symbolically illustrating the three phases of model compression, according to various aspects of the present disclosure and a system 100 for compressing a model, according to various aspects of the present disclosure. For example, FIG. 1 includes three illustrations of a model at three different phases of the model, according to various aspects of the present disclosure. For example, model 102 represents a model during a training phase. Model 104 represents the model during a compression phase. Model 104 is larger than model 102 to indicate that during the compression phase, the systems and techniques may add additional parameters to model 102 such that model 104 is larger than model 102. Model 106 represents the model during an inference phase. Model 106 is smaller than model 102 to indicate that model 102 has been compressed relative to model 102.

Additionally, FIG. 1 illustrates a system 100 including a compressor 108 that may compress models. For example, model 102 may be a trained model. System 100 may use model 102 as an input to compressor 108. Compressor 108 may generate model 106 based on model 102. To generate model 106, compressor 108 may generate model 104 (e.g., as an intermediate step in generating model 106).

Model 106 may be deployed (e.g., on a device) and may perform operations (e.g., at inference). Compressor 108 may train model 106 to perform the same operations that model 102 is trained to perform. Model 106 may be smaller than model 102 and may be less computationally expensive to run than model 102.

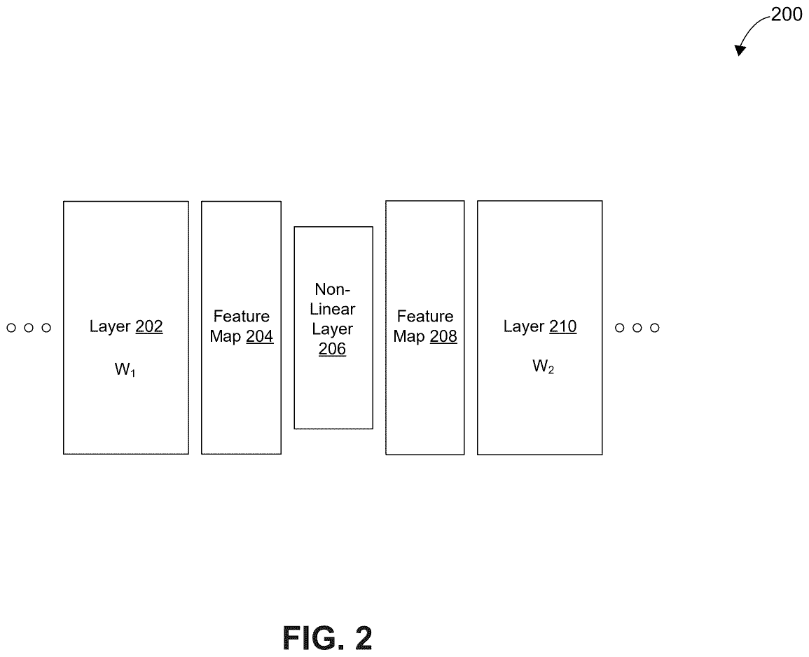

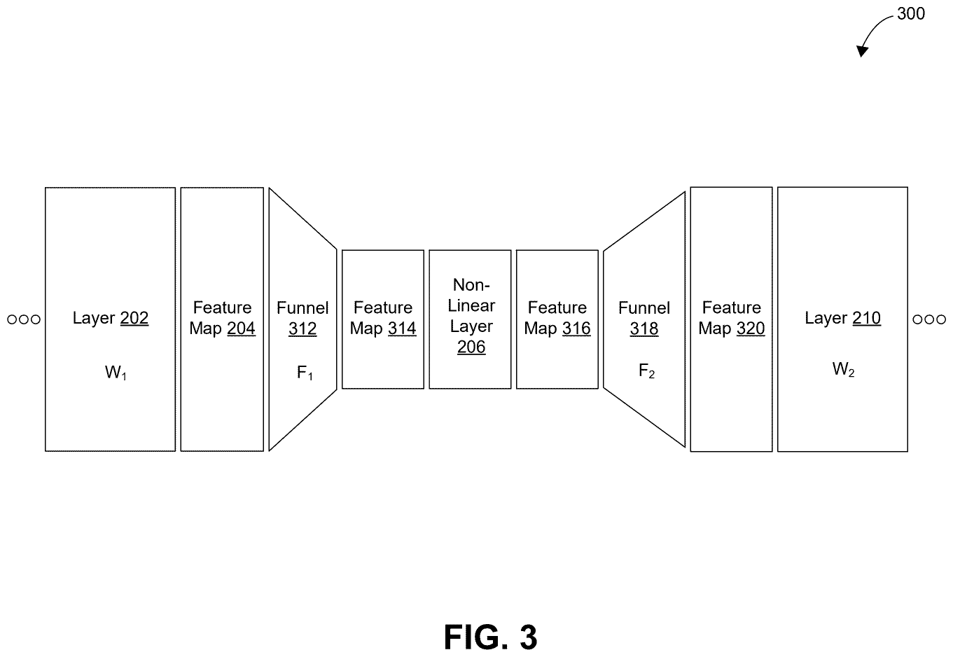

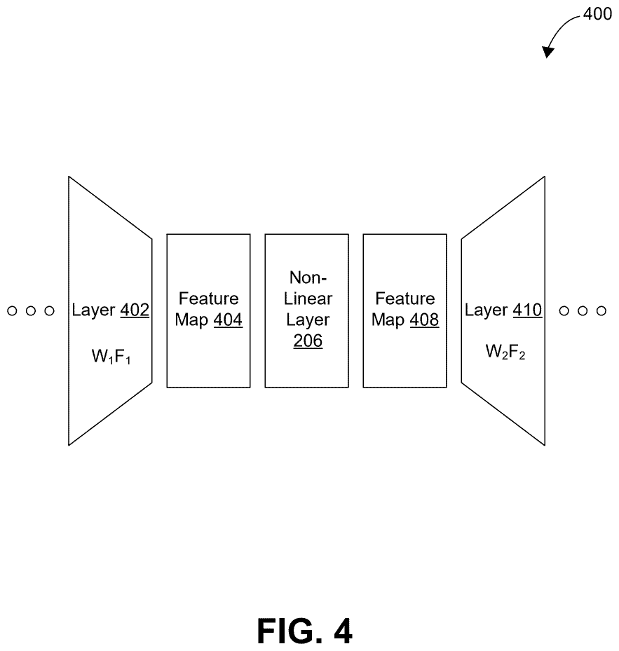

FIG. 2, FIG. 3, and FIG. 4 collectively illustrate a process of compressing a machine-learning model, according to various aspects of the present disclosure. For example, FIG. 2 is a block diagram illustrating an example model 200 (e.g., a machine-learning model). Model 200 is an example of model 102 of FIG. 1. Model 200 includes three layers as an example. Compressor 108 of FIG. 1 may compress models of any number of layers. Additionally, compressor 108 may compress any number of layers of a given model. For example, compressor 108 may compress some layers, but not others.

Model 200 includes a layer 202 (“W₁”), a non-linear layer 206, and a layer 210 (“W₂”). Layer 202 and layer 210 may include any number of weights, any number of inputs, and any number of outputs. Layer 202 and layer 210 may be, for example, transformer blocks, residual blocks, and feedforward blocks.

Layer 202 and layer 210 may be linear layers. For example, a given node of layer 202 or layer 210 may perform a linear operation on an input to generate an output, for example, the node may multiply an input by a weight to generate an output.

An input to layer 202 may be, or may include, data of any format. For example, the input to layer 202 may be, or may include, image data, audio data, video data, 3D data (e.g., a point cloud or voxel-based representation of a scene). Additionally or alternatively, the output may be, or may include, features output by another layer of model 200.

Layer 202 may process the input to generate feature map 204. Feature map 204 represents an output of layer 202. Feature map 204 may be, or may include, features, e.g., data processed by layer 202.

Non-linear layer 206 may process feature map 204 to generate feature map 208. Non-linear layer 206 may be, or may include, a layer of model 200 that may perform a non-linear operation.

Feature map 208 represents an output of non-linear layer 206. Feature map 208 may be, or may include, features, e.g., data processed by non-linear layer 206.

Layer 210 may process feature map 208 to generate an output. The input of layer 210 may be, or may include, data of any format. For example, the output of layer 210 may be, or may include, image data, audio data, video data, 3D data. Additionally or alternatively, the output may be features that may be processed by another layer of model 200.

Compressor 108 may add layers into models. For instance, compressor 108 may add layers which may be referred to as “funnels” into models. Funnels may be linear layers Fᵢ that may be inserted before or after existing linear layers Wᵢ. Fᵢ may reduce the dimensionality of the output channels of Wᵢ.

For example, compressor 108 may add layers into model 200 to obtain at model 300. Model 300 includes model 200 and the added layers. For instance, FIG. 3 is a block diagram illustrating an example model 300 (e.g., a machine-learning model) including funnels, according to various aspects of the present disclosure. For example, compressor 108 may add funnel 312 between layer 202 and non-linear layer 206 and add funnel 318 between non-linear layer 206 and layer 210.

Funnel 312 and funnel 318 may be layers of model 300 including nodes having weights. Funnel 312 and funnel 318 may perform linear operations on inputs to generate outputs.

Layer 202 may generate feature map 204 based on an input. Funnel 312 may generate feature map 314 based on feature map 204. Non-linear layer 206 may generate feature map 316 based on feature map 314. Funnel 318 may generate feature map 320 based on feature map 208. Layer 210 may generate an output based on feature map 320.

Funnel 312 may be sized such that feature map 314 is smaller than feature map 204. Funnel 312 may be referred to as a “funnel layer.” Additionally, funnel 318 may be sized such that feature map 320 is the same size as feature map 204. For example, funnel 312 may reduce the size of feature map 204 to generate feature map 314. Non-linear layer 206 may generate feature map 316 based on feature map 314 such that feature map 316 has the same size as feature map 314. Funnel 318 may increase the size of feature map 316 to generate feature map 320 such that feature map 320 has the same size as feature map 204. Funnel 318 may be referred to as a “reverse funnel” or a “reverse funnel layer.”

For example, model 200 may be a convolutional neural network and layer 202 and layer 210 may be convolutional layers. Layer 202 may have a size (channels_in, channels_out, 3, 3) such that feature map 204 has a size (channels_out, width, height) where the input feature map of Layer 202 is of size (channels_in, width, height) assuming a padding of 1 pixel. Compressor 108 may insert funnel 312 having a size of (channels_out, r, 1, 1) (where r<channels_out) such that feature map 314 has a size (r, width, height). Additionally, compressor 108 may insert funnel 318 having a size (r, channels_in, 1, 1) such that feature map 320 has a size (channels in, width, height). Layer 210 may have a size (channels_in, channels_out, 3, 3) such that an output of layer 210 has a size (channels_out, width, height).

As another example, model 200 may represent a dot product of a projected key and a projected query. For instance layer 202 may project a query vector to generate feature map 204. Layer 202 may have a size (channels_in, channels_out) such that feature map 204 has a size (channels_out). Layer 210 may project a key vector to generate feature map 320. Feature map 320 may have a size (channels_in, channels_out) such that feature map 320 has a size (channels_out). Non-linear layer 206 may perform a dot product of inputs. Compressor 108 may insert funnel 312 having a size (channels_out, r, 1, 1) (where r<channels_out) such that feature map 314 has a size (r). Additionally compressor 108 may insert funnel 318 having a size (channels_out, r, 1, 1) such that feature map 316 has a size (r). Non-linear layer 206 may determine and output the dot product of feature map 314 and feature map 316.

Compressor 108 may initialize the funnels. For example, compressor 108 may initialize the funnels by calculating a low rank projection of the inner channel dimensions.

For example, given layers W₁ and W₂, the systems and techniques may add funnels F₁ and F₂. The following are example layers:
a linear layer: xW₁W₂≈xW₁F₁F₂W₂
an attention layer: projections W_{q} and Wₖ and attention values

$$x {W}_{q} {W}_{k}^{T} {x}^{T} \approx x {W}_{q} {F}_{1} {F}_{2}^{T} {W}_{k}^{T} {x}^{T}$$

a convolutional layer: W₂(W₁(x))≈W₂(F₂(F₁((W₁(x))), where the funnels are 1×1 convolutions.

Initializing F₁ and F₂, for 2 consecutive linear layers W₁ and W₂ (it is assumed there are not non-linearities for initialization purposes) may involve the following steps. To initialize F₁ and F₂, the systems and techniques may calculate the singular value decomposition (SVD) of the merged layers SVD(W₁W₂)=UΣV. For convolutions the kernels may be reshaped such that the inner channels of the two convolutions are reduced in rank:

$${W}_{1} ∈ {R}^{{k}_{1} \times {k}_{1} \times in \times inner} , {W}_{2} ∈ {R}^{{k}_{2} \times {k}_{2} \times inner \times out}$$

### Reshaped:

$${W}_{1} ∈ {R}^{{k}_{1} * {k}_{1} * in \times inner} , {W}_{2} ∈ {R}^{inner \times {k}_{2} * {k}_{2} * out}$$

The dimensions of W₁W₂ are R^{k}^{₁}^{*k}^{₁}^{*in×k}^{₂}^{*k}^{₂}^{×out}, where k₁ and k₂ are kernel sizes of the first and second conv respectively.

The systems and techniques may initialize funnels F₁ and F₂ with:

$${F}_{1} = {W}_{1}^{- 1} \overline{U} {\overline{\sum }}^{1 / 2}$$

$${F}_{2} = {W}_{2}^{- 1} {\overline{V}}^{T} {\overline{\sum }}^{1 / 2}$$

$$\overline{U} = {U}_{[ : r ]}$$

where r is rank or the number of singular values to keep.

With the funnels inserted, compressor 108 may train model 300. For example, compressor 108 may train model 300 in substantially the same way that model 200 was trained. For example, model 300 may be trained to perform the same operations that model 200 was trained to perform. In some aspects, model 300 may be trained using the same training data and/or training process used to train model 200.

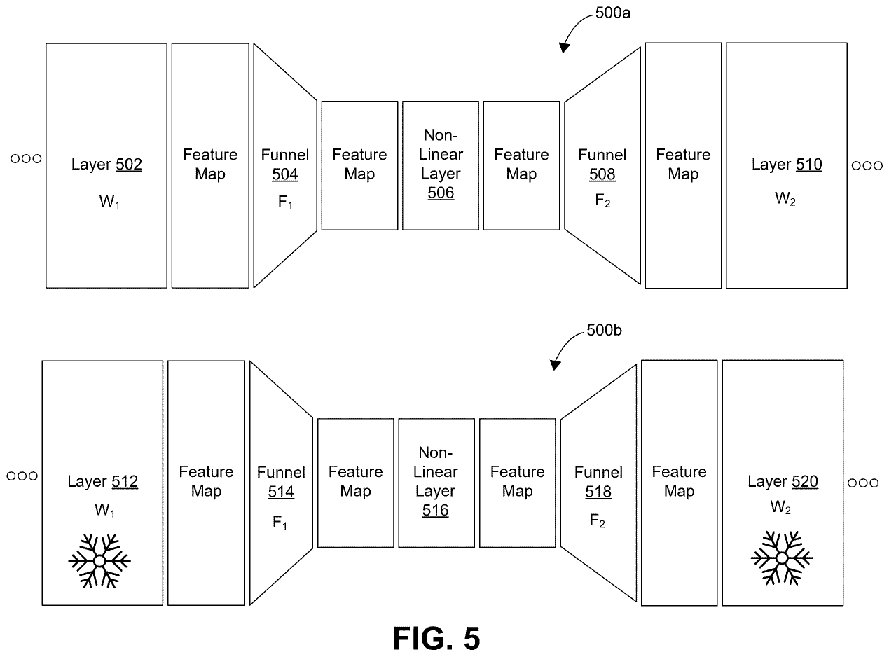

In some aspects, while training model 300, one or more layers (e.g., layers of model 200, such as layer 202 and/or layer 210) may be frozen. In other cases, while training model 300, the learning rates of one or more layers may be determined based on whether the one or more layers are part of model 200 or funnels. For example, compressor 108 may set learning rates of funnels added to generate model 300 higher than the training rates of layers of model 200. FIG. 5 is a diagram including an illustration of two instances of model 300, one including frozen weights and the other including all non-frozen weights. For example, layer 502 and layer 510 of example model 500a may be non-frozen (e.g., may be trained with funnel 504, non-linear layer 506, and/or layer 508). In contrast, layer 512 and layer 520 of example model 500b may be frozen (e.g., may not be trained with funnel 514, non-linear layer 516, and/or funnel 518).

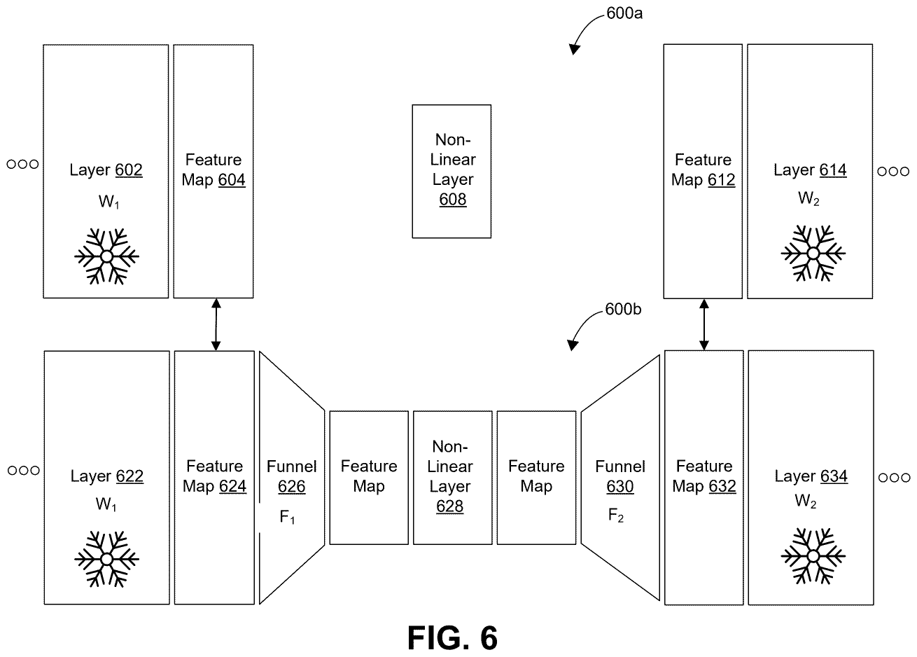

Additionally or alternatively, model 300 may be trained according to a teacher distillation training process. For example, FIG. 6 is a diagram illustrating a system in which a student model 600b may be trained based on a teacher model 600a, according to various aspects of the present disclosure. For example, the teacher model 600a may be the original model (e.g., model 200) with feature maps outputs (e.g., feature map 604 and feature map 612). The student model 600b may be the same as the teacher model 600a with two funnels (e.g., funnel 624 and funnel 632) in between every pair of consecutive layers (e.g., layer 622 and layer 634). The student model may be the same as, or may be substantially similar to model 300 of FIG. 3. The distillation which consists of regression between (a subset) of feature maps obtained in the teacher model (e.g., feature maps 604 and feature map 612) and the corresponding feature maps in the student model (e.g., feature maps 624 and feature map 632). For example, a regression between feature map 204 of FIG. 2 and feature map 204 of FIG. 3 and between feature map 208 of FIG. 2 and feature map 320 of FIG. 3. Examples of regression losses include L1, L2 or SmoothL1 loss.

Once the various layers of model 300 are trained, compressor 108 may merge funnels with layers. For example, after training compressor 108 may merge the weights Wᵢ and Fᵢ. Such a merging may not result in a loss of quality (because Wᵢ and Fᵢ are consecutive linear layers). The merged model may then be used, e.g., at inference. The merged model may be faster and smaller than the original model.

FIG. 4 is a diagram of an example model 400 generated according to various aspects of the present disclosure. For example, compressor 108 may merge layer 202 and funnel 312 of FIG. 3 to generate layer 402 and merge funnel 318 and layer 210 of FIG. 3 to generate layer 410.

Model 200 of FIG. 2 may be an example of model 102 of FIG. 1. Model 300 of FIG. 3 may be an example of model 104 of FIG. 1. Model 400 of FIG. 4 may be an example of model 106 of FIG. 1.

Returning to the paradigm of FIG. 1, model 200 may be a trained model (e.g., during a training phase of compression). Model 300 may be the model during a compression phase. Model 300 is larger than model 200 because model 300 includes funnels (e.g., funnel 312 and funnel 318). Model 400 may be the model during an inference phase. Model 400 is smaller than model 200 based on layer 402 and layer 410 being smaller than layer 202 and layer 210 respectively.

Model 400 may have a smaller memory footprint on a device than model 200 (e.g., based on layer 402 and layer 410 being smaller than layer 202 and layer 210 respectively). Further, it may be faster to generate results using model 400 than with model 200 because model 400 may be smaller than model 200. Thus, model 400 may be less computationally expensive to run than model 200. So, model 400 may be more suitable for deployment to a user device than model 200.

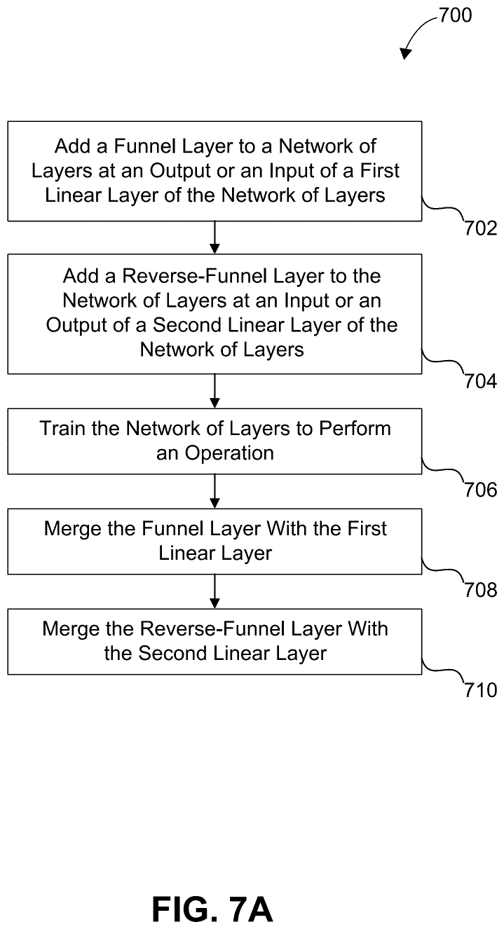

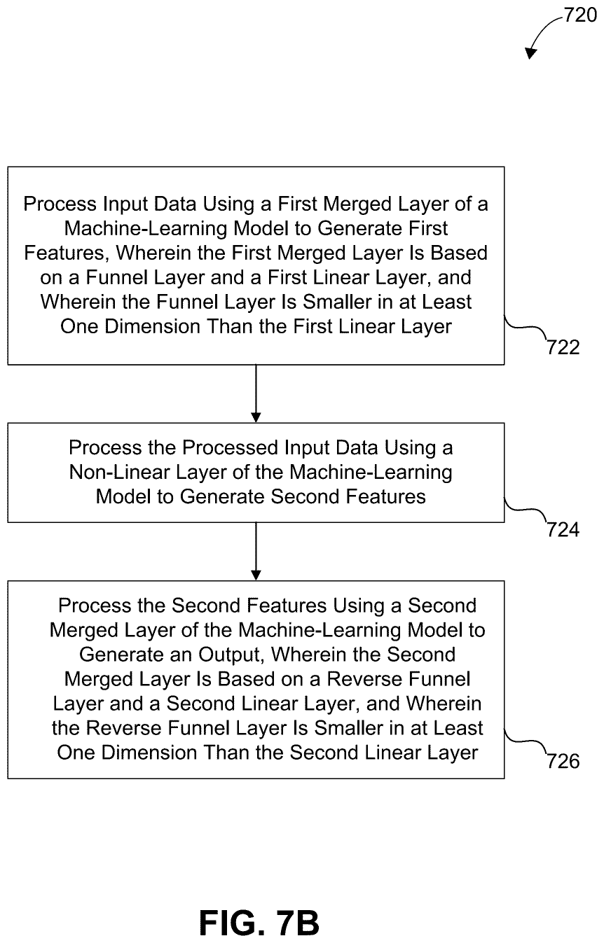

FIG. 7A is a flow diagram illustrating an example process 700 for compressing machine-learning models, in accordance with aspects of the present disclosure. One or more operations of process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 700. The one or more operations of process 700 may be implemented as software components that are executed and run on one or more processors.

At block 702, a computing device (or one or more components thereof) may add a funnel layer to a network of layers at an output or an input of a first linear layer of the network of layers. For example, compressor 108 may add funnel 312 to model 200 at an output of layer 202.

At block 704, the computing device (or one or more components thereof) may add a reverse-funnel layer to the network of layers at an input or an output of a second linear layer of the network of layers. For example, compressor 108 may add funnel 318 to model 200 at an input of layer 210.

In some aspects, the computing device (or one or more components thereof) may initialize the funnel layer and the reverse-funnel layer based on a singular value decomposition (SVD) of the first linear layer merged with the second linear layer. For example, compressor 108 may initialize funnel 312 and funnel 318 based on a SVD of layer 202 merged with layer 210.

In some aspects, the funnel layer is smaller than the first linear layer and the reverse-funnel layer is smaller than the second linear layer. For example, funnel 312 may be smaller than layer 202 and funnel 318 may be smaller than layer 210.

In some aspects, the funnel layer is smaller in a channels-out dimension than the first linear layer and the reverse-funnel layer is smaller in a channels-out dimension than the second linear layer. For example, funnel 312 may be smaller in a channels-out dimension than layer 202 and funnel 318 may be smaller in a channels-out dimension than layer 210.

In some aspects, the first merged layer (e.g., based on the funnel layer and the first linear layer) is smaller in a channels-out dimension than the first linear layer and the second merged layer (e.g., based on the reverse-funnel layer and the second linear layer) is smaller in a channels-out dimension than the second linear layer. For example, layer 402 may be smaller in a channels-out dimension than layer 202 and layer 410 may be smaller in a channels-out dimension than layer 210.

In some aspects, the first merged layer (e.g., based on the funnel layer and the first linear layer) is smaller than the first linear layer and the second merged layer (e.g., based on the reverse-funnel layer and the second linear layer) is smaller than the second linear layer. For example, layer 402 may be smaller than layer 202 and layer 410 may be smaller than layer 210.

In some aspects, the first linear layer may be, or may include, an attention block; a feedforward blocks; or a convolution block. For example, layer 202 (and layer 210) may be, or may include, an attention block, a feedforward blocks, or a convolution block.

At block 706, the computing device (or one or more components thereof) may train the network of layers to perform an operation. For example, compressor 108 may train model 300.

In some aspects, the operation may be associated with at least one of: video generation; video editing; video super resolution; or video inpainting. For example, compressor 108 may train model 300 to perform video generation, video editing, video super resolution, or video inpainting.

At block 708, the computing device (or one or more components thereof) may merge the funnel layer with the first linear layer. For example, compressor 108 may merge layer 202 and funnel 312 to generate layer 402.

At block 710, the computing device (or one or more components thereof) may merge the reverse-funnel layer with the second linear layer. For example, compressor 108 may merge 218//with layer 210 to generate layer 410.

In some aspects, the computing device (or one or more components thereof) may deploy the network of layers at a device. For example, model 400 may be deployed to a device to operate at an inference phase of operation.

In some aspects, the computing device (or one or more components thereof) may perform the operation using the network of layers. For example, model 400 may perform the operation for which model 300 (and/or model 200) was trained.

FIG. 7B is a flow diagram illustrating an example process 720 for compressing machine-learning models, in accordance with aspects of the present disclosure. One or more operations of process 720 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 720. The one or more operations of process 720 may be implemented as software components that are executed and run on one or more processors.

At block 722, a computing device (or one or more components thereof) may process input data using a first merged layer of a machine-learning model to generate first features, wherein the first merged layer is based on a funnel layer and a first linear layer, and wherein the funnel layer is smaller in at least one dimension than the first linear layer. For example, the computing device (or one or more components thereof) may process input data using layer 402. Layer 402 may be based on funnel 312 and layer 202. For example, layer 402 may be the result of merging funnel 312 and layer 202. Funnel 312 may be smaller than layer 202. Further, in some aspects, the first merged layer may be smaller than the first linear layer. For example, layer 402 may be smaller than layer 202.

In some aspects, the first merged layer may be a product of the funnel layer and the first linear layer. For example, compressor 108 may merge layer 202 and funnel 312 to generate layer 402 by performing a matrix multiplication of layer 202 and funnel 312.

In some aspects, the input data may be, or may include, an output from a previous layer of the machine-learning model. For example, data processed by model 400 may be, or may include, an output from a previous layer the machine-learning model that includes model 400.

In some aspects, the input data may be, or may include, an input image, a video frame, or input sensor data. For example, data processed by model 400 may be, or may include, an input image, a video frame, or input sensor data.

At block 724, the computing device (or one or more components thereof) may process the processed input data using a non-linear layer of the machine-learning model to generate second features. For example, the computing device (or one or more components thereof) may process an output of layer 402 (e.g., feature map 404) at non-linear layer 206 (e.g., to generate feature map 408).

At block 726, the computing device (or one or more components thereof) may process the second features using a second merged layer of the machine-learning model to generate an output, wherein the second merged layer is based on a reverse funnel layer and a second linear layer, and wherein the reverse funnel layer is smaller in at least one dimension than the second linear layer. For example, the computing device (or one or more components thereof) may process feature map 408 at layer 410 to generate an output. Layer 410 may be based on funnel 318 and layer 210. For example, layer 410 may be the result of merging funnel 318 and layer 210. Funnel 318 may be smaller than layer 210. Further, in some aspects, the second merged layer may be smaller than the second linear layer. For example, layer 410 may be smaller than layer 210.

In some aspects, the second merged layer may be a product of the reverse-funnel layer and the second linear layer. For example, compressor 108 may merge layer 210 and funnel 318 to generate layer 410 by performing a matrix multiplication of layer 210 and funnel 318.

In some aspects, the funnel layer and the reverse-funnel layer are trained together with the first linear layer and the second linear layer. For example, compressor 108 may train model 300 including layer 202, funnel 312, funnel 318, and layer 210.

In some aspects, during training of the funnel layer and the reverse funnel layer, the first linear layer and the second linear layer are frozen. For example, as compressor 108 trains model 300 including layer 202, funnel 312, funnel 318, and layer 210, layer 202 and layer 210 may be frozen, for example, as illustrated and described with regard to FIG. 5.

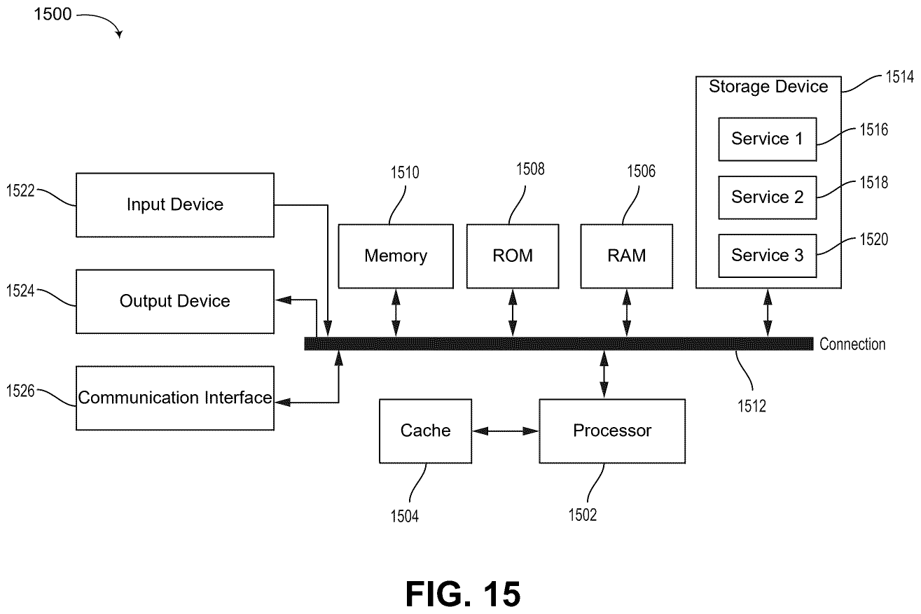

In some examples, as noted previously, the methods described herein (e.g., process 700 of FIG. 7A, process 720 of FIG. 7B, and/or other methods described herein) can be performed, in whole or in part, by a computing device or apparatus. In one example, one or more of the methods can be performed by compressor 108 of FIG. 1 or by another system or device. In another example, one or more of the methods (e.g., process 700, process 720, and/or other methods described herein) can be performed, in whole or in part, by the computing-device architecture 1500 shown in FIG. 15. For instance, a computing device with the computing-device architecture 1500 shown in FIG. 15 can include, or be included in, the components of the compressor 108 and can implement the operations of process 700, process 720 and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, process 720 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, process 720 and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can compress machine-learning models or systems.

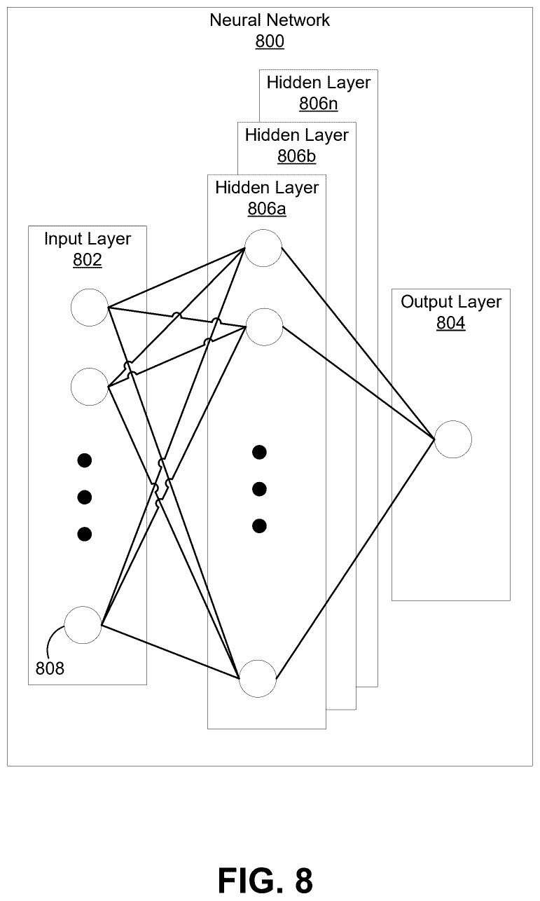

FIG. 8 is an illustrative example of a neural network 800 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. One or more layers of neural network 800 may be compressed by compressor 108, according to various aspects of the present disclosure. For example, one or more of input layer 802, hidden layers 806, or output layer 804 may be compressed by compressor 108, according to various aspects of the present disclosure.

An input layer 802 includes input data. In one illustrative example, input layer 802 can include data representing images, text, audio data, numerical data, etc. Neural network 800 includes multiple hidden layers, for example, hidden layers 806a, 806b, through 806n. The hidden layers 806a, 806b, through hidden layer 806n include “n” number of hidden layers, where “n” is an integer greater than or equal to one. The number of hidden layers can be made to include as many layers as needed for the given application. Neural network 800 further includes an output layer 804 that provides an output resulting from the processing performed by the hidden layers 806a, 806b, through 806n. In one illustrative example, output layer 804 can provide data representing images, text, audio data, numerical data, etc.

Neural network 800 may be, or may include, a multi-layer neural network of interconnected nodes. Each node can represent a piece of information. Information associated with the nodes is shared among the different layers and each layer retains information as information is processed. In some cases, neural network 800 can include a feed-forward network, in which case there are no feedback connections where outputs of the network are fed back into itself. In some cases, neural network 800 can include a recurrent neural network, which can have loops that allow information to be carried across nodes while reading in input.

Information can be exchanged between nodes through node-to-node interconnections between the various layers. Nodes of input layer 802 can activate a set of nodes in the first hidden layer 806a. For example, as shown, each of the input nodes of input layer 802 is connected to each of the nodes of the first hidden layer 806a. The nodes of first hidden layer 806a can transform the information of each input node by applying activation functions to the input node information. The information derived from the transformation can then be passed to and can activate the nodes of the next hidden layer 806b, which can perform their own designated functions. Example functions include convolutional, up-sampling, data transformation, and/or any other suitable functions. The output of the hidden layer 806b can then activate nodes of the next hidden layer, and so on. The output of the last hidden layer 806n can activate one or more nodes of the output layer 804, at which an output is provided. In some cases, while nodes (e.g., node 808) in neural network 800 are shown as having multiple output lines, a node has a single output and all lines shown as being output from a node represent the same output value.

In some cases, each node or interconnection between nodes can have a weight that is a set of parameters derived from the training of neural network 800. Once neural network 800 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 800 to be adaptive to inputs and able to learn as more and more data is processed.

Neural network 800 may be pre-trained to process the features from the data in the input layer 802 using the different hidden layers 806a, 806b, through 806n in order to provide the output through the output layer 804. In an example in which neural network 800 is used to identify features in images, neural network 800 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 800 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 800 is trained well enough so that the weights of the layers are accurately tuned.

For the example of identifying objects in images, the forward pass can include passing a training image through neural network 800. The weights are initially randomized before neural network 800 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 800, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 800 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 800 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and n denotes a learning rate. The learning rate can be set to any suitable value, with a high learning rate including larger weight updates and a lower value indicating smaller weight updates.

Neural network 800 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 800 can include any other deep network other than a CNN, such as an autoencoder, a deep belief nets (DBNs), a Recurrent Neural Networks (RNNs), among others.

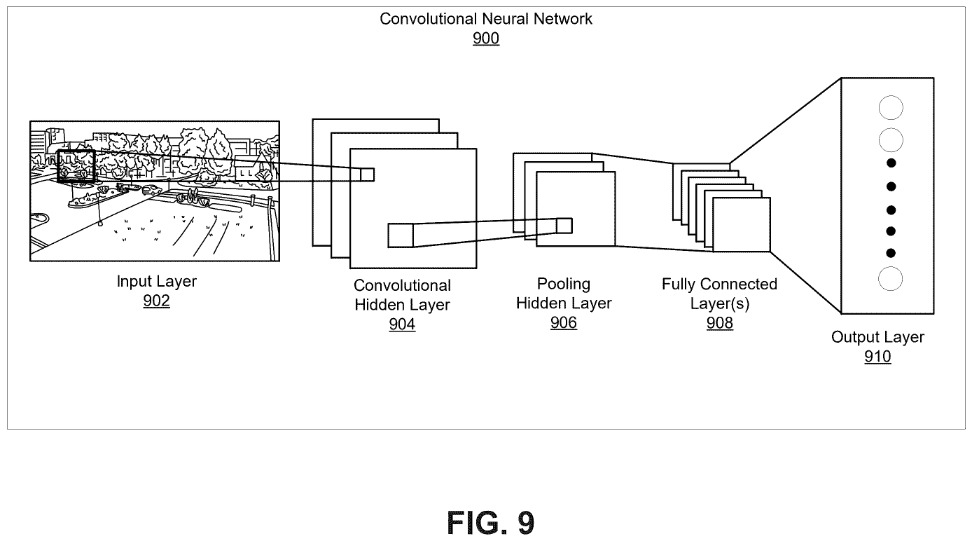

FIG. 9 is an illustrative example of a convolutional neural network (CNN) 900. The input layer 902 of the CNN 900 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 904, an optional non-linear activation layer, a pooling hidden layer 906, and fully connected layer 908 (which fully connected layer 908 can be hidden) to get an output at the output layer 910. While only one of each hidden layer is shown in FIG. 9, one of ordinary skill will appreciate that multiple convolutional hidden layers, non-linear layers, pooling hidden layers, and/or fully connected layers can be included in the CNN 900. As previously described, the output can indicate a single class of an object or can include a probability of classes that best describe the object in the image.

The first layer of the CNN 900 can be the convolutional hidden layer 904. The convolutional hidden layer 904 can analyze image data of the input layer 902. Each node of the convolutional hidden layer 904 is connected to a region of nodes (pixels) of the input image called a receptive field. The convolutional hidden layer 904 can be considered as one or more filters (each filter corresponding to a different activation or feature map), with each convolutional iteration of a filter being a node or neuron of the convolutional hidden layer 904. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 904. Each connection between a node and a receptive field for that node learns a weight and, in some cases, an overall bias such that each node learns to analyze its particular local receptive field in the input image. Each node of the convolutional hidden layer 904 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 904 is due to each node of the convolutional layer being applied to its corresponding receptive field. For example, a filter of the convolutional hidden layer 904 can begin in the top-left corner of the input image array and can convolve around the input image. As noted above, each convolutional iteration of the filter can be considered a node or neuron of the convolutional hidden layer 904. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 904. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 904.

The mapping from the input layer to the convolutional hidden layer 904 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 904 can include several activation maps in order to identify multiple features in an image. The example shown in FIG. 9 includes three activation maps. Using three activation maps, the convolutional hidden layer 904 can detect three different kinds of features, with each feature being detectable across the entire image.

In some examples, a non-linear hidden layer can be applied after the convolutional hidden layer 904. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 900 without affecting the receptive fields of the convolutional hidden layer 904.

The pooling hidden layer 906 can be applied after the convolutional hidden layer 904 (and after the non-linear hidden layer when used). The pooling hidden layer 906 is used to simplify the information in the output from the convolutional hidden layer 904. For example, the pooling hidden layer 906 can take each activation map output from the convolutional hidden layer 904 and generates a condensed activation map (or feature map) using a pooling function. Max-pooling is one example of a function performed by a pooling hidden layer. Other forms of pooling functions be used by the pooling hidden layer 906, such as average pooling, L2-norm pooling, or other suitable pooling functions. A pooling function (e.g., a max-pooling filter, an L2-norm filter, or other suitable pooling filter) is applied to each activation map included in the convolutional hidden layer 904. In the example shown in FIG. 9, three pooling filters are used for the three activation maps in the convolutional hidden layer 904.

In some examples, max-pooling can be used by applying a max-pooling filter (e.g., having a size of 2×2) with a stride (e.g., equal to a dimension of the filter, such as a stride of 2) to an activation map output from the convolutional hidden layer 904. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 904 having a dimension of 24×24 nodes, the output from the pooling hidden layer 906 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 900.

The final layer of connections in the network is a fully-connected layer that connects every node from the pooling hidden layer 906 to every one of the output nodes in the output layer 910. Using the example above, the input layer includes 28×28 nodes encoding the pixel intensities of the input image, the convolutional hidden layer 904 includes 3×24×24 hidden feature nodes based on application of a 5×5 local receptive field (for the filters) to three activation maps, and the pooling hidden layer 906 includes a layer of 3×12×12 hidden feature nodes based on application of max-pooling filter to 2×2 regions across each of the three feature maps. Extending this example, the output layer 910 can include ten output nodes. In such an example, every node of the 3×12×12 pooling hidden layer 906 is connected to every node of the output layer 910.

The fully connected layer 908 can obtain the output of the previous pooling hidden layer 906 (which should represent the activation maps of high-level features) and determines the features that most correlate to a particular class. For example, the fully connected layer 908 can determine the high-level features that most strongly correlate to a particular class and can include weights (nodes) for the high-level features. A product can be computed between the weights of the fully connected layer 908 and the pooling hidden layer 906 to obtain probabilities for the different classes. For example, if the CNN 900 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 910 can include an M-dimensional vector (in the prior example, M=10). M indicates the number of classes that the CNN 900 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

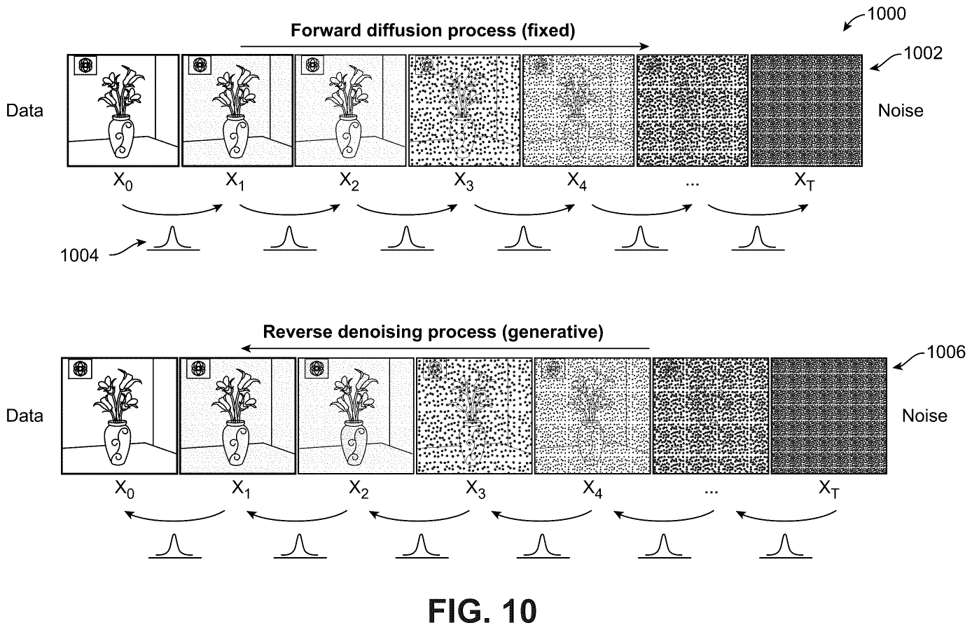

FIG. 10 provides two sets of images 1000 that show the forward diffusion process (which is fixed) and the reverse diffusion process (which is learned) of a diffusion model. As shown in the forward diffusion process of FIG. 10, noise 1004 is gradually added to a first set of images 1002 at different time steps for a total of T time steps (e.g., making up a Markov chain), producing a sequence of noisy samples X₁ through X_{T}.

Diffusion models from a training perspective will take an image and will slowly add noise to the image to obscure the information in the image. In some aspects, the noise 1004 is Gaussian noise. Each time step can correspond to each consecutive image of the first set of images 1002 shown in FIG. 10. The initial image X₀ of FIG. 10 is of a vase of flowers. Addition of the noise 1004 to each image (corresponding to noisy samples X₁ to X_{T}) results in gradual diffusion of the pixels in each image until the final image (corresponding to sample X_{T}) essentially matches the noise distribution. For example, by adding the noise, each data sample X₁ through X_{T} gradually loses its distinguishable features as the time step becomes larger, eventually resulting in the final sample X_{T} being equivalent to the target noise distribution, for instance a unit variance zero-Gaussian N (0, 1).

The second set of images 1006 shows the reverse diffusion process in which X_{T} is the starting point with a noisy image (e.g., one that has Gaussian noise). The diffusion model can be trained to reverse the diffusion process (e.g., by training a model p_{θ}(xₜ₋₁|xₜ)) to generate new data. In some aspects, a diffusion model can be trained by finding the reverse Markov transitions that maximize the likelihood of the training data. By traversing backwards along the chain of time steps, the diffusion model can generate the new data. For example, as shown in FIG. 10, the reverse diffusion process proceeds to generate X₀ as the image of the vase of flowers. In other cases, the input data and output data can vary based on the task for which the diffusion model is trained.

As noted above, the diffusion model is trained to be able to denoise or recover the original image X₀ in an incremental process as shown in the second set of images 1006. In some aspects, the neural network of the diffusion model can be trained to recover Xₜ given Xₜ₋₁, such as provided in the below example equation:

$$q ( {x}_{t} \vert {x}_{t - 1} ) = N ( {x}_{t} ; \sqrt{1 - {β}_{t}} {x}_{t - 1} , {β}_{t} I )$$

A diffusion kernel can be defined as:

$$Define {\hat{∝}}_{t} = {\prod }_{s = 1}^{t} ( 1 - {β}_{s} ) \to q ( {x}_{t} \vert {x}_{0} ) = N ( {x}_{t} ; \sqrt{{\hat{∝}}_{t}} {x}_{0} , ( 1 - {\hat{∝}}_{t} ) I )$$

Sampling can be defined as follows:

$${x}_{t} = \sqrt{{\hat{∝}}_{t}} {x}_{0} + \sqrt{1 - {\hat{∝}}_{t}} ε where ε ∼ N ( 0 , 1 ) .$$

In some cases, the βₜ values schedule (also referred to as a noise schedule) is designed such that \hat{∝}_{T}→0 and q(x_{T}|x₀)≈ [symbol] (x_{T};0,I).

The diffusion model runs in an iterative manner to incrementally generate the input image X₀. In one example, the model may have twenty steps. However, in other examples, the number of steps can vary.

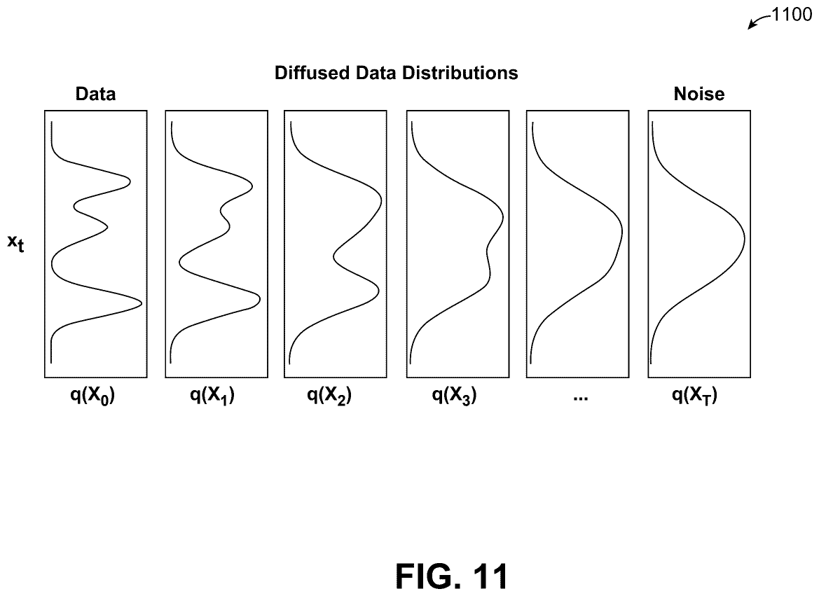

FIG. 11 is a diagram 1100 illustrating how diffusion data is distributed from initial data to noise using a diffusion model in the forward diffusion direction, in accordance with some aspects. Note that the initial data q(X₀) is detailed in the initial stage of the diffusion process. An illustrative example of the data q(X₀) is the initial image of the flowers in a vase shown in FIG. 10. As the diffusion model iterates and iteratively adds sampled noise to the data from t=0 to t=T, as shown in FIG. 11, the data becomes nosier and may ultimately result in pure noise (e.g., at q(X_{T})). The example of FIG. 11 illustrates the progression of the data and how it becomes diffused with noise in the forward diffusion process.

In some aspects, the diffused data distribution (e.g., as shown in FIG. 11) can be as follows:

$$q ( {x}_{t} ) = \int q ( {x}_{0} , {x}_{t} ) {dx}_{0} = \int q ( {x}_{0} ) q ( {x}_{t} \vert {x}_{0} ) {dx}_{0} .$$

In the above equation, q(xₜ) represents the diffused data distribution, q(x₀,xₜ) represents the joint distribution, q(x₀) represents the input data distribution, and q(xₜ|x₀) is the diffusion kernel. In this regard, the model can sample xₜ˜q(xₜ) by first sampling x₀˜q(x₀) and then sampling xₜ˜q(xₜ|x₀) (which may be referred to as ancestral sampling). The diffusion kernel takes the input and returns a vector or other data structure as output.

The following is a summary of a training algorithm and a sampling algorithm for a diffusion model. A training algorithm can include the following steps:

| 1: | repeat |
|---|---|
| 2: | x₀ ~ q(x₀) |
| 3: | t ~ Uniform ({1, ..., T}) |
| 4: | ∈ ~ [symbol] (0, I) |
| 5: | Take gradient descent step on |
| ∇_{Ø}∥ ∈ − ∈_{Ø} (\sqrt{\hat{∝}ₜ x₀}+ \sqrt{1 − \hat{∝}ₜ}∈, t) ∥² | |
| 6: | until converged |

A sampling algorithm can include the following steps:

1: x_{T} ~ [symbol] (0, I)
2: for t = T, ... , 1 do
3: z ~ [symbol] (0, I)
$4 : {x}_{t - 1} = \frac{1}{\sqrt{{\hat{∝}}_{t}}} ( {x}_{t} - \frac{1 - {\hat{∝}}_{t}}{\sqrt{1 - {\hat{∝}}_{t}}} {∈}_{∅} ( {x}_{t} , t ) ) + {σ}_{t} z$
5: end for
6: return x₀

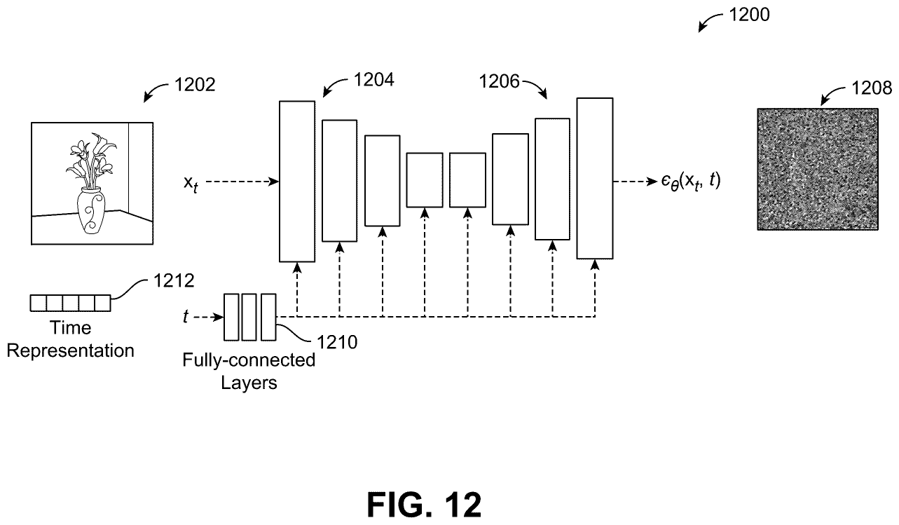

FIG. 12 is a diagram illustrating a U-Net architecture 1200 for a diffusion model, in accordance with some aspects. One or more layers of architecture 1200 (e.g., layers of contracting path 1204 and corresponding layers of expanding path 1206) may be compressed by compressor 108, according to various aspects of the present disclosure.

The initial image 1202 (e.g., a vase of flowers) is provided to the U-Net architecture 1200 which includes a series of residual networks (ResNet) blocks and self-attention layers to represent the network ϵ_{Θ}(xₜ, t). The U-Net architecture 1200 also includes fully-connected layers 1210. In some cases, time representation 1212 can be sinusoidal positional embeddings or random Fourier features. Noisy output 1208 from the forward diffusion process is also shown.

The U-Net architecture 1200 includes a contracting path 1204 and an expanding path 1206 as shown in FIG. 12, which gives it the U-shaped architecture. The contracting path 1204 can be a convolutional network that includes repeated convolutional layers (that apply convolutional operations), each followed by a rectified linear unit (ReLU) and a max pooling operation. When images are being processed (e.g., the image 1202) during the contracting path 1204, the spatial information of the image 1202 is reduced as features are generated. The expanding path 1206 combines the features and spatial information through a sequence of up-convolutions and concatenations with high-resolution features from the contracting path 1204. Some of the layers can be self-attention layers, which leverage global interactions between semantic features at the end of the encoder to explicitly model full contextual information.

Latent diffusion models (also referred to as stable diffusion models) introduce a diffusion process in the latent space of a machine learning model (e.g., variational autoencoder (VAE) neural network), making the machine learning model more efficient while enabling high-resolution image synthesis. For example, an Encoder (ε)-Decoder (D) pair of a VAE can be trained to capture a low-dimensional latent distribution given by z=ε(x) such that x≈D(z). The denoising process outlined above can be formulated in this latent space by training a U-Net (e.g., U-Net architecture 1200 of FIG. 12), which may include ResNet blocks and attention modules in some cases, to predict the noise introduced in the forward diffusion process, which optimizes the objective given by the following:

$${min}_{θ} {𝔼}_{z 0 , ϵ - N ( 0 , 1 ) , t \sim U ( 0 , T )} {‖ ϵ - {ϵ}_{θ} ( {z}_{t} , t , c ) ‖}_{2}^{2}$$

Here, ϵ is the total noise introduced to the noise-free latent z₀˜E(x) by the scheduler in T steps, zₜ is the corresponding partially-noisy latent at diffusion timestep t, and c is conditioning (e.g., text prompt embedding provided as input). With the predicted noise ϵ_{θ}, denoising diffusion implicit models (DDIM) sampling can be applied on z_{T} over T steps iteratively to recover z₀ in the original latent data distribution, such as in the following:

$${z}_{t - 1} = \sqrt{{α}_{t - 1}} \frac{{z}_{t} - \sqrt{1 - {α}_{t} {ϵ}_{θ}}}{\sqrt{{α}_{t}}} + \sqrt{1 - {α}_{t} {ϵ}_{θ}} ,$$

where αₜ is a parameter for noise scheduler.

When adopting Stable Diffusion (SD) to video generation or video editing, a key factor is to ensure the temporal consistency of a generated frame relative to one or more previous frames in the video. In addition to modifications to the U-Net model (such as temporal attention and 2+1D convolutions), it helps to rely on control signals, and/or DDIM inversion to start the denoising with a correlated set of noise latents.

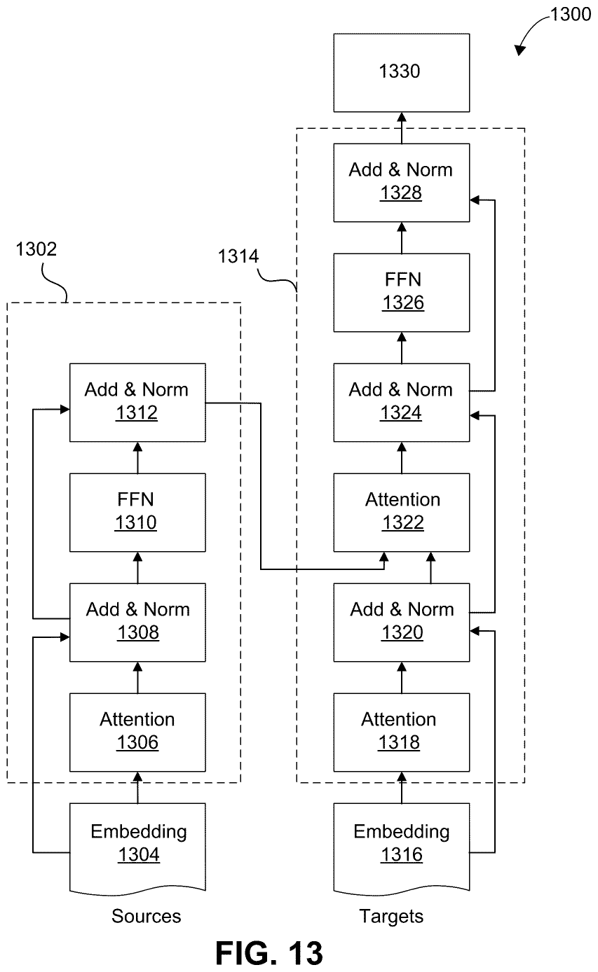

FIG. 13 is a block diagram of an example transformer in accordance with some aspects of the disclosure. One or more layers of neural network 800 may be compressed by compressor 108, according to various aspects of the present disclosure. For example, one or more layers of multi-head self-attention engine 1312, fully-connected feed-forward network 1314, masked multi-head self-attention engine 1332, multi-head attention engine 1334, fully-connected feed-forward network 1326 may be compressed by compressor 108, according to various aspects of the present disclosure.

In a convolutional neural network (CNN) model, the number of operations required to relate signals from two arbitrary input or output positions grows in the distance between positions, which makes learning dependencies at different distant positions challenging for a CNN model. A transformer 1300 reduces the operations of learning dependencies by using an encoder 1310 and a decoder 1330 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1310 is composed of a stack of six identical layers and each layer has two sub-layers. The first sub-layer is a multi-head self-attention engine 1312, and the second sub-layer is a fully-connected feed-forward network 1314. A residual connection (not shown) connects around each of the sub-layers followed by normalization.

In this example transformer 1300, the decoder 1330 is also composed of a stack of six 6 identical layers. The decoder also includes a masked multi-head self-attention engine 1332, a multi-head attention engine 1334 over the output of the encoder 1310, and a fully-connected feed-forward network 1326. Each layer includes a residual connection (not shown) around the layer, which is followed by layer normalization. The masked multi-head self-attention engine 1332 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1340 to encode positions because the model does not contain recurrence and convolution and relative or absolute position of the tokens is needed. In the transformer 1300, the positional encodings are added to the input embeddings at the bottom layer of the encoder 1310 and the decoder 1330. The positional encodings are summed with the embeddings because the positional encodings and embeddings have the same dimensions. A corresponding position decoder 1350 is configured to decode the positions of the embeddings for the decoder 1330.

In some aspects, the transformer 1300 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1300 can process input sequences of variable length, making it well-suited for natural language processing tasks where input lengths can vary greatly. Additionally, the self-attention mechanism allows the transformer 1300 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

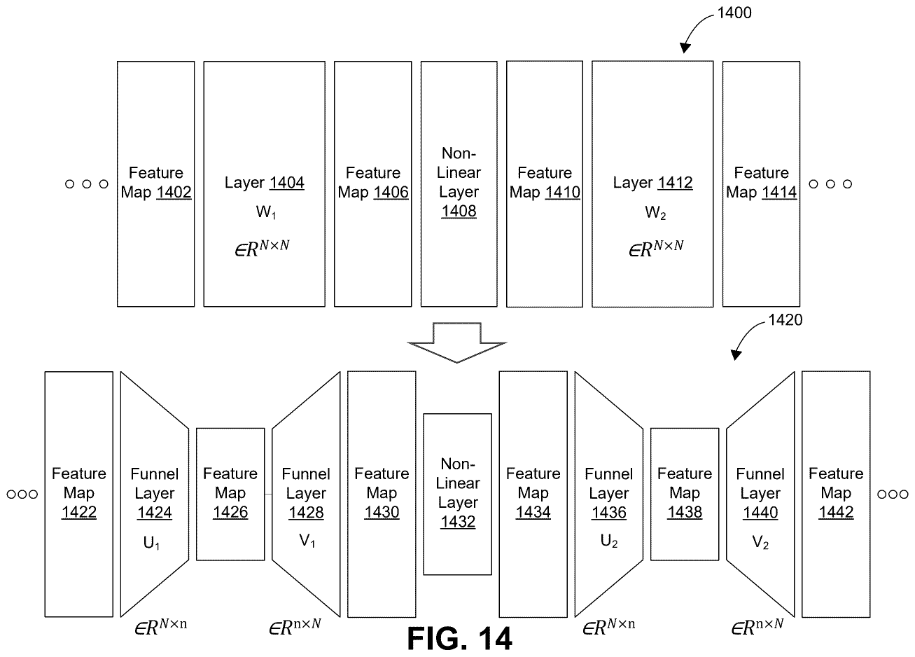

FIG. 14 is a block diagram illustrating an example process of singular value decomposition that may be used, according to various aspects of the present disclosure to initialize funnels. For example, the compressor 108 may use Singular Value Decomposition (SVD) weight compression to determine values to initialize funnels (e.g., funnel 312 and/or funnel 318).

SVD compression may decompose each layer into two layers as the low-rank decomposition of the original weights. For example, W_{N×N} is decomposed as W_{N×N}≈U_{N×n}V_{n×N} where n<<N.

SVD may reduce the number of parameters: N×N=→2n×N, if n<0.5*N.

The compressed model is fine-tuned to recover the performance drop caused by SVD decomposition.

FIG. 15 illustrates an example computing-device architecture 1500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1500 may include, implement, or be included in any or all of compressor 108 of FIG. 1 and/or other devices, modules, or systems described herein. Additionally or alternatively, computing-device architecture 1500 may be configured to perform process 700, process 720 and/or other process described herein.

The components of computing-device architecture 1500 are shown in electrical communication with each other using connection 1512, such as a bus. The example computing-device architecture 1500 includes a processing unit (CPU or processor) 1502 and computing device connection 1512 that couples various computing device components including computing device memory 1510, such as read only memory (ROM) 1508 and random-access memory (RAM) 1506, to processor 1502.

Computing-device architecture 1500 can include a cache of high-speed memory connected directly with, in close proximity to, or integrated as part of processor 1502. Computing-device architecture 1500 can copy data from memory 1510 and/or the storage device 1514 to cache 1504 for quick access by processor 1502. In this way, the cache can provide a performance boost that avoids processor 1502 delays while waiting for data. These and other modules can control or be configured to control processor 1502 to perform various actions. Other computing device memory 1510 may be available for use as well. Memory 1510 can include multiple different types of memory with different performance characteristics. Processor 1502 can include any general-purpose processor and a hardware or software service, such as service 1 1516, service 2 1518, and service 3 1520 stored in storage device 1514, configured to control processor 1502 as well as a special-purpose processor where software instructions are incorporated into the processor design. Processor 1502 may be a self-contained system, containing multiple cores or processors, a bus, memory controller, cache, etc. A multi-core processor may be symmetric or asymmetric.

To enable user interaction with the computing-device architecture 1500, input device 1522 can represent any number of input mechanisms, such as a microphone for speech, a touch-sensitive screen for gesture or graphical input, keyboard, mouse, motion input, speech and so forth. Output device 1524 can also be one or more of a number of output mechanisms known to those of skill in the art, such as a display, projector, television, speaker device, etc. In some instances, multimodal computing devices can enable a user to provide multiple types of input to communicate with computing-device architecture 1500. Communication interface 1526 can generally govern and manage the user input and computing device output. There is no restriction on operating on any particular hardware arrangement and therefore the basic features here may easily be substituted for improved hardware or firmware arrangements as they are developed.

Storage device 1514 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1506, read only memory (ROM) 1508, and hybrids thereof. Storage device 1514 can include services 1516, 1518, and 1520 for controlling processor 1502. Other hardware or software modules are contemplated. Storage device 1514 can be connected to the computing device connection 1512. In one aspect, a hardware module that performs a particular function can include the software component stored in a computer-readable medium in connection with the necessary hardware components, such as processor 1502, connection 1512, output device 1524, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hard ware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for processing data, the apparatus comprising: at least one memory; and at least one processor coupled to the at least one memory and configured to: process input data using a first merged layer of a machine-learning model to generate first features, wherein the first merged layer is based on a funnel layer and a first linear layer, and wherein the funnel layer is smaller in at least one dimension than the first linear layer; process the processed input data using a non-linear layer of the machine-learning model to generate second features; and process the second features using a second merged layer of the machine-learning model to generate an output, wherein the second merged layer is based on a reverse funnel layer and a second linear layer, and wherein the reverse funnel layer is smaller in at least one dimension than the second linear layer.
Aspect 2. The apparatus of aspect 1, wherein the first merged layer is a product of the funnel layer and the first linear layer.
Aspect 3. The apparatus of any one of aspects 1 or 2, wherein the second merged layer is a product of the reverse funnel layer and the second linear layer.
Aspect 4. The apparatus of any one of aspects 1 to 3, wherein the funnel layer and the reverse funnel layer are trained together with the first linear layer and the second linear layer.
Aspect 5. The apparatus of aspect 4, wherein during training of the funnel layer and the reverse funnel layer, the first linear layer and the second linear layer are frozen.
Aspect 6. The apparatus of any one of aspects 1 to 5, wherein the input data comprises an output from a previous layer of the machine-learning model.
Aspect 7. The apparatus of any one of aspects 1 to 6, wherein the input data comprises an input image, a video frame, or input sensor data.
Aspect 8. An apparatus for compressing machine-learning models, the apparatus comprising: at least one memory; and at least one processor coupled to the at least one memory and configured to: add a funnel layer to a network of layers at an output or an input of a first linear layer of the network of layers; add a reverse-funnel layer to the network of layers at an input or an output of a second linear layer of the network of layers; train the network of layers to perform an operation; merge the funnel layer with the first linear layer; and merge the reverse-funnel layer with the second linear layer.
Aspect 9. The apparatus of aspect 8, wherein the at least one processor is configured to deploy the network of layers at a device.
Aspect 10. The apparatus of any one of aspects 8 or 9, wherein the at least one processor is configured to perform the operation using the network of layers.
Aspect 11. The apparatus of any one of aspects 8 to 10, wherein the at least one processor is configured to initialize the funnel layer and the reverse-funnel layer based on a singular value decomposition (SVD) of the first linear layer merged with the second linear layer.
Aspect 12. The apparatus of any one of aspects 8 to 11, wherein the funnel layer is smaller than the first linear layer and the reverse-funnel layer is smaller than the second linear layer.
Aspect 13. The apparatus of any one of aspects 8 to 12, wherein the funnel layer is smaller in a channels-out dimension than the first linear layer and the reverse-funnel layer is smaller in a channels-out dimension than the second linear layer.
Aspect 14. The apparatus of any one of aspects 8 to 13, wherein the first linear layer comprises at least one of: an attention block; a feedforward blocks; or a convolution block.
Aspect 15. The apparatus of any one of aspects 8 to 14, wherein the operation is associated with at least one of: video generation; video editing; video super resolution; or video inpainting.
Aspect 16. A method for processing data, the method comprising: processing input data using a first merged layer of a machine-learning model to generate first features, wherein the first merged layer is based on a funnel layer and a first linear layer, and wherein the funnel layer is smaller in at least one dimension than the first linear layer; processing the processed input data using a non-linear layer of the machine-learning model to generate second features; and processing the second features using a second merged layer of the machine-learning model to generate an output, wherein the second merged layer is based on a reverse funnel layer and a second linear layer, and wherein the reverse funnel layer is smaller in at least one dimension than the second linear layer.
Aspect 17. The method of aspect 16, wherein the first merged layer is a product of the funnel layer and the first linear layer.
Aspect 18. The method of any one of aspects 16 or 17, wherein the second merged layer is a product of the reverse funnel layer and the second linear layer.
Aspect 19. The method of any one of aspects 16 to 18, wherein the funnel layer and the reverse funnel layer are trained together with the first linear layer and the second linear layer.
Aspect 20. The method of aspect 19, wherein during training of the funnel layer and the reverse funnel layer, the first linear layer and the second linear layer are frozen.
Aspect 21. The method of any one of aspects 16 to 20, wherein the input data comprises an output from a previous layer of the machine-learning model.
Aspect 22. The method of any one of aspects 16 to 21, wherein the input data comprises an input image, a video frame, or input sensor data.
Aspect 23. A method for compressing machine-learning models, the method comprising: adding a funnel layer to a network of layers at an output or an input of a first linear layer of the network of layers; adding a reverse-funnel layer to the network of layers at an input or an output of a second linear layer of the network of layers; training the network of layers to perform an operation; merging the funnel layer with the first linear layer; and merging the reverse-funnel layer with the second linear layer.
Aspect 24. The method of aspect 23, further comprising deploying the network of layers at a device.
Aspect 25. The method of any one of aspects 23 or 24, further comprising performing the operation using the network of layers.
Aspect 26. The method of any one of aspects 23 to 25, further comprising initializing the funnel layer and the reverse-funnel layer based on a singular value decomposition (SVD) of the first linear layer merged with the second linear layer.
Aspect 27. The method of any one of aspects 23 to 26, wherein the funnel layer is smaller than the first linear layer and the reverse-funnel layer is smaller than the second linear layer.
Aspect 28. The method of any one of aspects 23 to 27, wherein the funnel layer is smaller in a channels-out dimension than the first linear layer and the reverse-funnel layer is smaller in a channels-out dimension than the second linear layer.
Aspect 29. The method of any one of aspects 23 to 28, wherein the first linear layer comprises at least one of: an attention block; a feedforward blocks; or a convolution block.
Aspect 30. The method of any one of aspects 23 to 29, wherein the operation is associated with at least one of: video generation; video editing; video super resolution; or video inpainting.
Aspect 31. A non-transitory computer-readable storage medium having stored thereon instructions that, when executed by at least one processor, cause the at least one processor to: process input data using a first merged layer of a machine-learning model to generate first features, wherein the first merged layer is based on a funnel layer and a first linear layer, and wherein the funnel layer is smaller in at least one dimension than the first linear layer; process the processed input data using a non-linear layer of the machine-learning model to generate second features; and process the second features using a second merged layer of the machine-learning model to generate an output, wherein the second merged layer is based on a reverse funnel layer and a second linear layer, and wherein the reverse funnel layer is smaller in at least one dimension than the second linear layer.
Aspect 32. A non-transitory computer-readable storage medium having stored thereon instructions that, when executed by at least one processor, cause the at least one processor to: add a funnel layer to a network of layers at an output or an input of a first linear layer of the network of layers; add a reverse-funnel layer to the network of layers at an input or an output of a second linear layer of the network of layers; train the network of layers to perform an operation; merge the funnel layer with the first linear layer; and merge the reverse-funnel layer with the second linear layer.
Aspect 33. A non-transitory computer-readable storage medium having stored thereon instructions that, when executed by at least one processor, cause the at least one processor to perform operations according to any of aspects 16 to 30.
Aspect 34. An apparatus for providing virtual content for display, the apparatus comprising one or more means for perform operations according to any of aspects 16 to 30.

What is claimed is:

1. An apparatus for processing data, the apparatus comprising:
at least one memory; and
at least one processor coupled to the at least one memory and configured to:
process input data using a first merged layer of a machine-learning model to generate first features, wherein the first merged layer is based on a funnel layer and a first linear layer, and wherein the funnel layer is smaller in at least one dimension than the first linear layer;
process the processed input data using a non-linear layer of the machine-learning model to generate second features; and
process the second features using a second merged layer of the machine-learning model to generate an output, wherein the second merged layer is based on a reverse funnel layer and a second linear layer, and wherein the reverse funnel layer is smaller in at least one dimension than the second linear layer.

2. The apparatus of claim 1, wherein the first merged layer is a product of the funnel layer and the first linear layer.

3. The apparatus of claim 1, wherein the second merged layer is a product of the reverse funnel layer and the second linear layer.

4. The apparatus of claim 1, wherein the funnel layer and the reverse funnel layer are trained together with the first linear layer and the second linear layer.

5. The apparatus of claim 4, wherein during training of the funnel layer and the reverse funnel layer, the first linear layer and the second linear layer are frozen.

6. The apparatus of claim 1, wherein the input data comprises an output from a previous layer of the machine-learning model.

7. The apparatus of claim 1, wherein the input data comprises an input image, a video frame, or input sensor data.

8. An apparatus for compressing machine-learning models, the apparatus comprising:
at least one memory; and
at least one processor coupled to the at least one memory and configured to:
add a funnel layer to a network of layers at an output or an input of a first linear layer of the network of layers;
add a reverse-funnel layer to the network of layers at an input or an output of a second linear layer of the network of layers;
train the network of layers to perform an operation;
merge the funnel layer with the first linear layer; and
merge the reverse-funnel layer with the second linear layer.

9. The apparatus of claim 8, wherein the at least one processor is configured to deploy the network of layers at a device.

10. The apparatus of claim 8, wherein the at least one processor is configured to perform the operation using the network of layers.

11. The apparatus of claim 8, wherein the at least one processor is configured to initialize the funnel layer and the reverse-funnel layer based on a singular value decomposition (SVD) of the first linear layer merged with the second linear layer.

12. The apparatus of claim 8, wherein the funnel layer is smaller than the first linear layer and the reverse-funnel layer is smaller than the second linear layer.

13. The apparatus of claim 8, wherein the funnel layer is smaller in a channels-out dimension than the first linear layer and the reverse-funnel layer is smaller in a channels-out dimension than the second linear layer.

14. The apparatus of claim 8, wherein the first linear layer comprises at least one of:
an attention block;
a feedforward blocks; or
a convolution block.

15. The apparatus of claim 8, wherein the operation is associated with at least one of:
video generation;
video editing;
video super resolution; or
video inpainting.

16. A method for processing data, the method comprising:
processing input data using a first merged layer of a machine-learning model to generate first features, wherein the first merged layer is based on a funnel layer and a first linear layer, and wherein the funnel layer is smaller in at least one dimension than the first linear layer;
processing the processed input data using a non-linear layer of the machine-learning model to generate second features; and
processing the second features using a second merged layer of the machine-learning model to generate an output, wherein the second merged layer is based on a reverse funnel layer and a second linear layer, and wherein the reverse funnel layer is smaller in at least one dimension than the second linear layer.

17. The method of claim 16, wherein the first merged layer is a product of the funnel layer and the first linear layer.

18. The method of claim 16, wherein the second merged layer is a product of the reverse funnel layer and the second linear layer.

19. The method of claim 16, wherein the funnel layer and the reverse funnel layer are trained together with the first linear layer and the second linear layer.

20. The method of claim 19, wherein during training of the funnel layer and the reverse funnel layer, the first linear layer and the second linear layer are frozen.
